(19) United States
(12) Patent Application Publication
(10) Pub. No.: US 2015/0046328 A1
(43) Pub. Date: Feb. 12, 2015

(54) SECURED POINT OF SALE TRANSACTION USING FINGERPRINT RECOGNITION

(71) Applicant: Manu Mitra, Wilmington (US)

(72) Inventor: Manu Mitra, Wilmington (US)

(21) Appl. No.: 13/964,995

(22) Filed: Aug. 12, 2013

(51) Int. Cl. G06Q 20/40; G06K 9/00; G06F 17/30

(52) U.S. Cl. CPC G06Q 20/40145; G06Q 20/4012; G06F 17/30244; G06K 9/00087
USPC 705/44

(57) ABSTRACT

A method for operating a computerized system for processing cashless and cardless financial transactions, the method comprising the steps of: registering a user's fingerprint with an entity, by using the user's fingerprint to create a first image of the user's fingerprint and then storing the first image of the user's fingerprint in a digital database of the entity; associating the first image of the user's fingerprint, now registered, with at least one debit or credit account of the user; receiving, through a transaction device, a request to authorize a financial transaction, wherein said request comprises a second image of the user's fingerprint taken by the transaction device at the time the request to authorize the financial transaction is made; and, authenticating the request to authorize the financial transaction, by comparing in real time, through a computer network, the second image with the first image of the user's fingerprint.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The invention relates generally to electronics and payment methods and systems, and more particularly to an improved secured point of sale transaction using fingerprint recognition.

2. Description of the Related Art

Today, people have to carry cash or debit/credit cards to the stores or other vendors in order to pay for the purchased goods or services. These payment systems and methods, based on on-hand cash, debit or credit card, exposes people to the risk of being robbed, to the risk of theft and to the risk of loss of such valuable items. In addition, debit and credit card numbers are stolen everyday online by ill-intended individuals, who then sell them to others or use them themselves. Thus, there is a need for more convenient (cashless and cardless), safe and secure (fingerprint based) methods and systems for making payments.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment, when a user wishes to make a payment, the user places his/her fingerprint on a fingerprint scanning device, which scans the user's fingerprint. If a user's fingerprint account is found in a bank server, then a list of credit/debit card accounts associated with the user's fingerprint account is displayed. The user can then select which credit/debit card account to use for the transaction. For additional security, the user may be asked to enter the PIN for the selected credit/debit card. For more additional security, the user may be also asked to sign on a digital sign board. Thus, an advantage is that the user does not have to carry cash or debit/credit cards. Another advantage is that if user's debit/credit cards or their numbers are stolen or lost, they cannot be used by thieves, finders or other ill-intended persons to make fraudulent transactions. This is because the user's fingerprint is also needed in order to make transactions from user's accounts.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 illustrates a schematic view of an exemplary transaction device for performing transactions using fingerprint recognition, according to an embodiment.

FIG. 2 illustrates a schematic view of an exemplary transaction system for performing transactions using fingerprint recognition, according to another embodiment.

FIG. 3 illustrates a flow diagram of a method for performing secured transactions using fingerprint recognition, according to another embodiment.

FIG. 4 illustrates a flow diagram of another method for performing secured transactions using fingerprint recognition, according to another embodiment.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

As used herein and throughout this disclosure, the term “transaction device” refers to any electronic device capable of communicating across a network. A transaction device may have a processor, a memory, a transceiver, an input (e.g., a fingerprint scanner), and an output (e.g., a display). Examples of such devices include point-of-sale (POS) devices, smartphones, portable computers, etc. The memory stores applications, software, or logic. Examples of processors are computer processors (processing units), microprocessors, digital signal processors, controllers and microcontrollers, etc.

Transaction devices communicate with other elements (e.g., servers) via a network, for instance, the internet. A network typically includes a plurality of elements such as servers that host logic for performing tasks on the network. Servers may be placed at several logical points on the network. Servers may further be in communication with databases and can enable transaction devices to access the contents of a database. For instance, an authentication server hosts or is in communication with a database having authentication information for users of a transaction device.

For the following description, it can be assumed that most correspondingly labeled structures across the figures (e.g., 101 and 201, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

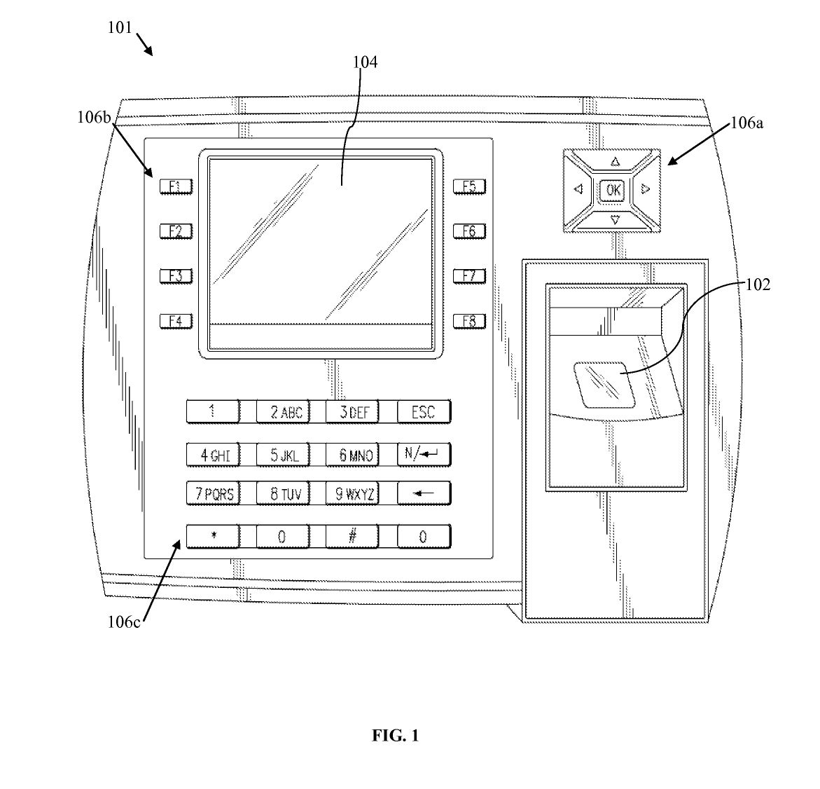

FIG. 1 illustrates a schematic view of an exemplary transaction device for performing transactions using fingerprint recognition, according to an embodiment. As shown, the transaction device 101 may have several components, including a fingerprint scanner 102, a display 104 and an input, including various buttons 106a-c, to facilitate user's interaction with the transaction device as it will described hereinafter.

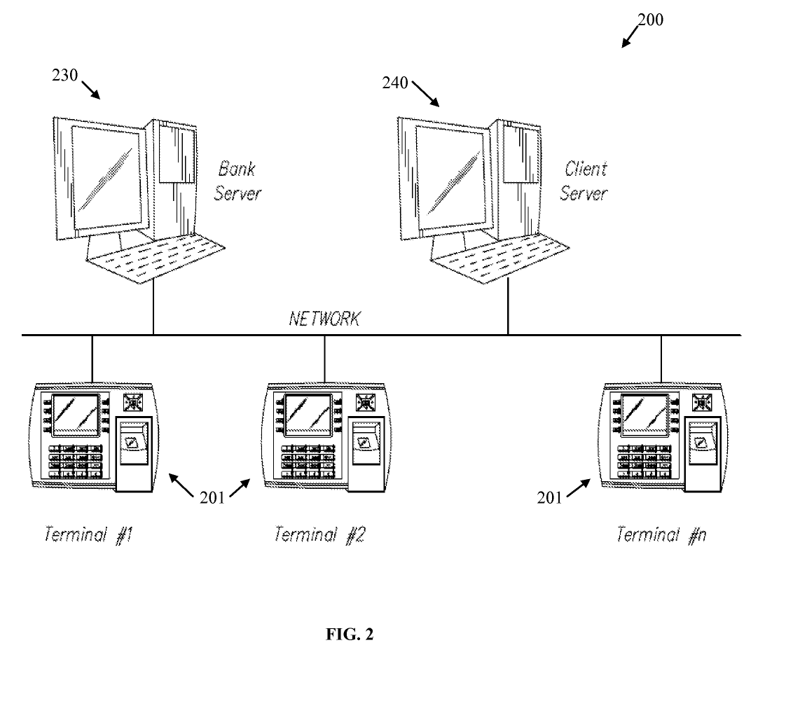

FIG. 2 illustrates a schematic view of an exemplary transaction system for performing transactions using fingerprint recognition, according to another embodiment. As shown, the exemplary transaction system 200 may have a plurality of transaction devices (terminals) 201 which communicate via a network with servers including bank server(s) 230 and a client server(s) 240. The transaction devices 201 are typically located at a merchant's place of business (e.g., at a store), but may be located in other places as well, such as a bus, a train station, and so on. The client server(s) 240 is typically owned and/or operated by the entity (e.g., a merchant) receiving a payment from a user. The bank server(s) 230 is typically, but not always, owned and/or operated by the financial institution (e.g., a bank) where the account from which payment will be made is located. It should be noted that other servers (not shown) may be part of the system 200, such as servers owned and/or operated by an intermediary used to facilitate the transfer of payment from bank server 230 to client server 240.

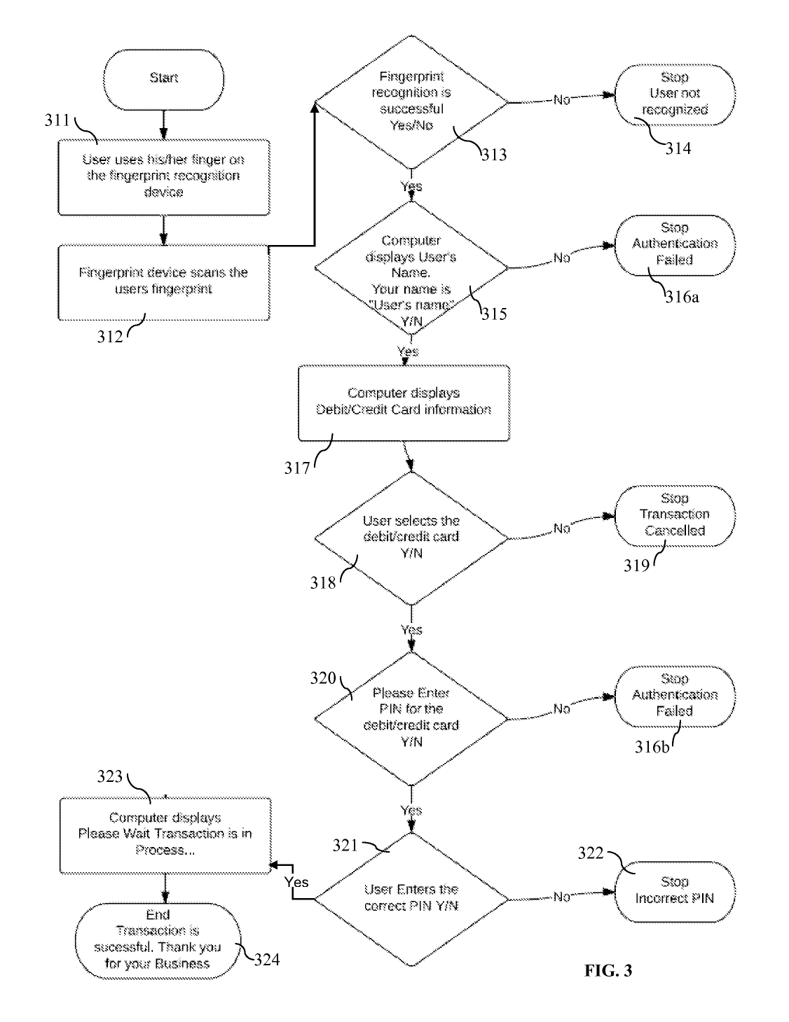

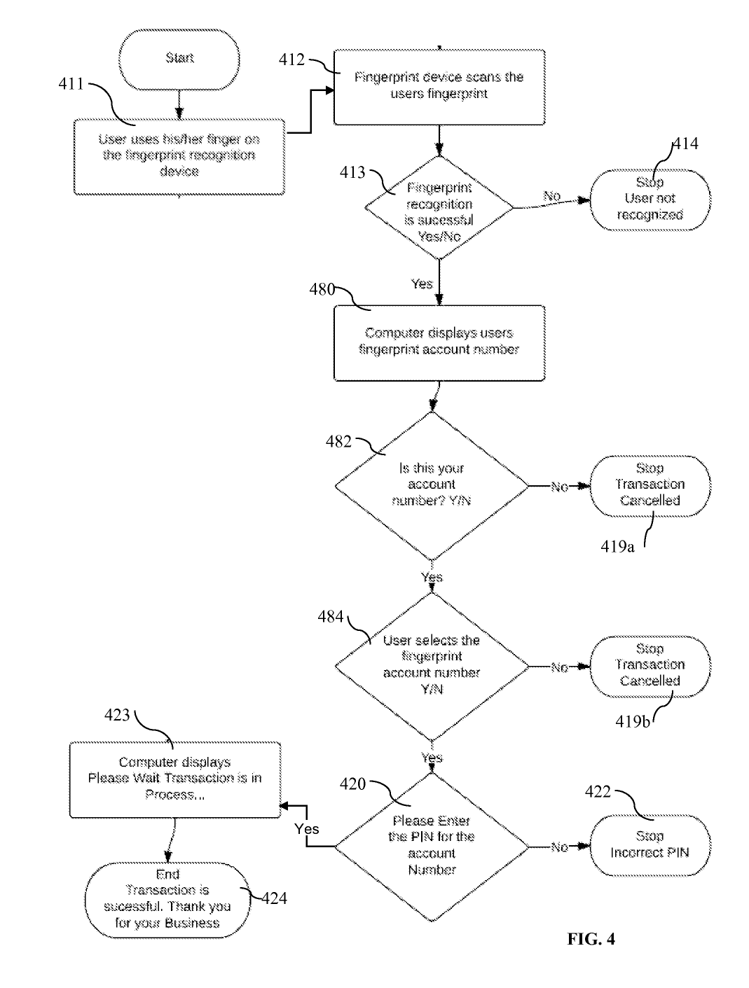

The functions and the operation of the transaction devices 101/201 and of transaction system 200 will be better understood when described in connection with the two exemplary methods for performing secured transactions using fingerprint recognition depicted in FIG. 3 and FIG. 4. Again, FIG. 3 illustrates a flow diagram of a method for performing secured transactions using fingerprint recognition, according to another embodiment. FIG. 4 illustrates a flow diagram of another method for performing secured transactions using fingerprint recognition, according to another embodiment.

In order to use the two payment transaction methods (FIG. 3-4), typically a user would first have to register his/her fingerprint with a financial institution such as a bank. This may be accomplished by, for example, requiring the user to walk into a local branch of a bank (e.g., the bank where user has accounts) to have his/her fingerprint scanned and stored into the bank's database which may reside on, or be in communication with, bank server 230. Typically, a unique fingerprint account number (e.g., 1234567890) would be generated by the bank server 230, and associated with the user's fingerprint image. While the use of a fingerprint account number is optional, it is preferred since it facilitates, for example, the administration and use of the fingerprint database. For example, a search of the database using the fingerprint account number instead of an image of the fingerprint may be much more convenient and technically easier to implement. Alternatively, a fingerprint account number may not be used at all and instead an image of the user's fingerprint may be used solely to organize the fingerprint database and to perform transactions as described hereinafter.

Next, in order to use the first payment method (depicted in FIG. 3), the user has to link his/her fingerprint image, and thus the fingerprint account number if one is used, since for this method typically the fingerprint account number is different than user's debit/credit account number, to one or more debit/credit card accounts opened at the bank where user registers his/her fingerprint, or opened at other banks. It should be noted that, for example, agreements between various banks may allow users to register their fingerprints with one bank and then link to that fingerprint image and/or account, debit or credit accounts from more than one bank. Also, fingerprint registration would typically require users to be physically present in a branch location for proper identification and for scanning of their fingerprint. However, the linking of one or more debit/credit accounts to the user's fingerprint image and/or account may be done while the user is physically present in local office of the bank, or, by using other means such as secure online portals provided for example by the bank with which user's fingerprint is registered.

According to the first transaction method depicted in FIG. 3, to make a payment, a user may be prompted to start by placing (step 311) his/her finger on the fingerprint scanner and recognition device 102 (FIG. 1) of the transaction device 101/201 (e.g., a merchant's POS terminal), which scans (step 312) the user's fingerprint, and attempts to validate (steps 313-315) the scanned fingerprint image by comparing it to the fingerprint images that are stored in the bank server 230. It should be noted that bank server 230 may be the server of a particular bank, or, a central server or a group of networked servers that serve more than one bank. Alternatively, the transaction device 201 may be configured to run the scanned fingerprint against databases of various banks. In either case the goal is to ascertain that user's fingerprint is registered with at least one bank and that a debit/credit account is linked to user's fingerprint.

If it is determined that the fingerprint is registered, the transaction device 101/201 may be configured to display user's name on display 104 and to ask the user to confirm that the name is correct, by, for example, pressing one of the buttons 106a-c (steps 315-316a). Since the generated fingerprint image and/or associated fingerprint account number is linked with a user's credit or debit card account number, the transaction device 101/201 pulls the debit/credit card account number and displays on the screen 104 (preferably last four digits of debit/credit card account number only).

If the user has several credit or debit cards with different credit card account numbers, as stated earlier, all the debit/credit card account numbers may be linked to one single fingerprint image and/or associated fingerprint account number of the user. Thus, whenever the user uses his/her fingerprint (since it is linked with multiple debit/credit card accounts), the transaction device 101/201 pulls and display all the debit/credit card accounts associated with that fingerprint account or image. The user may then choose from the list one debit or credit card for the transaction, if he/she recognizes the account numbers displayed (steps 317-319).

After the user selects one of the debit/credit cards, for additional security of the transaction, the user may be asked to enter a personal identification number (PIN) for the selected debit/credit card (steps 320, 316b). If the PIN is entered correctly (steps 321-323), the transaction device 101/201 may display various confirmation messages such as the ones shown in steps 323-324. It should be noted that for even more additional security, or as an alternative, the user may be required to sign on a digital sign board, which may be part of display 104, such that to ensure that the transaction is done only by the user.

According to this first transaction method (FIG. 3), preferably, for security reasons, fingerprint information is not stored in the local (merchant) server 240. All the fingerprint information is preferably stored in the secured bank server(s) 230 only. If any fingerprint information needs to be temporarily stored in the local merchant servers, it should preferably be automatically deleted after the transaction ends, whether successfully (step 324) or unsuccessfully (e.g., step 322). Client/merchant servers are typically used only to store the information of the transaction such as transaction id and some credit card information (if required for the transaction to be successful). Furthermore, preferably, all the fingerprint based transactions are done through secured communication channels and data transfers are encrypted.

Thus, by using this transaction method, a user need not carry any cash or physical credit cards or debit cards, if the user has one or more cards that are linked to his registered fingerprint image and/or fingerprint account. As such, related risks, such as risks of cash or cards being forgotten, lost or stolen, are eliminated by this method.

This transaction method may easily gain universal acceptance as it can be implemented as an inexpensive upgrade of existing point-of-sale devices by adding/integrating to/in them a fingerprint scanner, and of the banks' computer systems by adding fingerprint scanners, fingerprint databases and supporting software to register users' fingerprints, link them to debit/credit accounts of the users and to support the other functions described above in relation to this method.

From the above description, it should also be apparent that in addition to the benefit of not needing to carry any cash or cards, the users also do not need to carry with them their fingerprint account number or any other identification items such as a radio frequency identity card (RFID). The user's fingerprint itself is a form of authentication.

Another benefit of this first method is that it provides a high degree of security because fingerprint information (such as fingerprint account number, fingerprint image etc.,) is preferably never disclosed to merchants and is stored in the secured bank servers only (preferably, only last four digits of credit card account is disclosed to the merchant).

And again, as stated earlier, the user can have multiple debit/credit card accounts with different credit limits, and issued by different banks, all linked to one fingerprint.

FIG. 4 illustrates a flow diagram of another/alternative method for performing secured transactions using fingerprint recognition, according to another embodiment. In order to use this method, first, a user have to also register his/her fingerprint as described above (e.g., to the local bank). Next, once user's fingerprint image is stored in the bank's database, the user may have an account number of that fingerprint from which the user may be allowed to make payments. In other words, for this method, the user preferably has only one account number, which associates user's fingerprint with a source of funds.

This account number may be sixteen digits long (e.g., 1234 1234 1234 1234), such as a credit card number, but can also be shorter or longer. Larger account numbers are preferred for increased security. Optionally, a user may receive a physical card (like a credit card) or a virtual/digital card with the account number, especially if the account number is long, and thus, difficult for the user to remember it. A virtual card is preferred since eliminates the need for carrying a physical card. The virtual card may be delivered to the user, for example, through a secure online portal (using SSL, login, etc), directly to the user's mobile or smart phone. For additional security, a personal identification number (PIN) may also be issued and associated with the account number.

When user uses his/her fingerprint (step 411) on the fingerprint scanning/recognition device 102, users fingerprint is scanned (step 412) and validated with the bank server 230. If validation is successful (steps 413-414), the account number is displayed (step 480) on the screen 104 of the transaction device 101/201. While the entire account number may be needed sometimes to be disclosed to the merchant server 240 to properly process/settle the payment, preferably, for security reasons, only a portion of the account number (e.g., last four digits) is displayed on screen 104 and/or stored into the merchant/client server 240.

Next, in steps 482, 484, 419a-b, and 420-422 the user is asked to select and confirm the account number and, for additional security of the transaction, to add a PIN number associated with the account. For this method as well, for even more security, the user may also be asked to sign his signature. Finally, if account is confirmed and PIN entered correctly, the payment/transaction is processed and corresponding messages may be displayed (steps 423-424) on the transaction device's screen 104.

It should be observed that using this second/alternative method, the user cannot typically have multiple credit limits from various banks on the same fingerprint account. While this may be a limitation, this method also has significant advantages. An advantage that it is not expensive to implement as a secured fingerprint recognition payment method, because of its simplicity. Another advantage is that it requires less maintenance and administration at the backend because no credit cards are linked with that account. Another advantage is that it provides for a faster transaction than the first method because there is no need to search for all linked credit/debit cards for that user.

It should be noted that as an option, under both methods described above, the user may be allowed to also make payments the traditional way (e.g., by entering the account number and other credentials in an online checkout module), when, for example, the fingerprint scanning feature is not available. However, this option should be preferably avoided as it exposes the user to traditional risks (e.g., theft of account numbers, unauthorized payments using stolen accounts, etc), which these two methods, and variations thereof, using the fingerprint recognition aspect, are designed to eliminate.

It should be noted that, the transaction device 101/201 disclosed herein may be for example an ATM machine or the like, which the user may use to make a payment to him/herself, by for example, withdrawing cash from one of his/her accounts associated with his/her registered fingerprint.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

As used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims. Use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the described methods. Acts, elements and features discussed only in connection with one embodiment are not intended to be excluded from a similar role in other embodiments.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

For means-plus-function limitations, if any, recited in the claims, the means are not intended to be limited to the means disclosed in this application for performing the recited function, but are intended to cover in scope any means, known now or later developed, for performing the recited function.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

What is claimed is:

1. A method for operating a computerized system for processing cashless and cardless financial transactions, the method comprising the steps of:
registering a user's fingerprint with an entity, by using the user's fingerprint to create a first image of the user's fingerprint and then storing the first image of the user's fingerprint in a digital database of the entity;
associating the first image of the user's fingerprint, now registered, with at least one debit or credit account of the user;
receiving, through a transaction device, a request to authorize a financial transaction, wherein said request comprises a second image of the user's fingerprint taken by the transaction device at the time the request to authorize the financial transaction is made;
authenticating the request to authorize the financial transaction, by comparing in real time, through a computer network, the second image with the first image of the user's fingerprint;
sending fingerprint authentication results to the transaction device;
communicating said fingerprint authentication results to the user through the transaction device;
if said fingerprint authentication results are positive, asking the user to input into the transactional device additional user identification data;
authorizing the financial transaction if the additional user identification data inputted by the user into the transactional device is correct; and
completing the financial transaction without permitting storing of the first or second image of the user's fingerprint, or copies thereof, into the transaction device or into any other device or database different than the entity's digital database, except temporarily if necessary for the processing of the financial transaction to be successful.

2. The method of claim 1, wherein said entity is a bank.

3. The method of claim 2, wherein the at least one debit or credit account of the user is open at said bank.

4. The method of claim 1, further comprising generating a fingerprint account number when registering the user's fingerprint, and associating said fingerprint account number with the first image of the user's fingerprint, and thus, with the at least one debit or credit account of the user.

5. The method of claim 1, wherein the financial transaction is a payment to a merchant.

6. The method of claim 1, wherein the communicating of the fingerprint authentication results to the user through the transaction device comprises displaying user's name on the display of the transaction device and asking the user to confirm that the displayed name is user's name.

7. The method of claim 1, wherein the communicating of the fingerprint authentication results to the user through the transaction device comprises displaying, for each of the at least one debit or credit account associated with the user's fingerprint, a portion of the account number of the at least one debit or credit account on the display of the transaction device and asking the user to select one of the displayed portion of the account number of the at least one debit or credit account, thus confirming that it corresponds to one of the at least one debit or credit account associated with the user's fingerprint and indicating that the financial transaction should be processed from the selected account.

8. The method of claim 7, wherein the additional user identification data is a personal identification number (PIN) associated with the selected account.

9. The method of claim 7, wherein the additional user identification data is a personal signature signed on the display of the transactional device.

10. The method of claim 4, wherein the first image of the user's fingerprint and the user's fingerprint account number are associated with only one debit or credit account of the user, and wherein, communicating the fingerprint authentication results to the user through the transaction device comprises displaying on the display of the transaction device at least a portion of the user's fingerprint account number and asking the user to confirm that the displayed at least a portion corresponds to user's fingerprint account number.

11. A computer network system for processing cashless and cardless financial transactions, the system comprising an entity's server and a transaction device, and the system being configured to implement a process comprising the steps of:
registering a user's fingerprint with the entity, by using the user's fingerprint to create a first image of the user's fingerprint and then storing the first image of the user's fingerprint in a digital database of the entity;
associating the first image of the user's fingerprint, now registered, with at least one debit or credit account of the user;
receiving, through the transaction device, a request to authorize a financial transaction, wherein said request comprises a second image of the user's fingerprint, obtained by the transaction device at the time the request to authorize the financial transaction is made;
authenticating the request to authorize the financial transaction, by comparing in real time, the second image with the first image of the user's fingerprint;
sending fingerprint authentication results to the transaction device;
communicating said fingerprint authentication results to the user through the transaction device;
if said fingerprint authentication results are positive, asking the user to input into the transactional device additional user identification data;
authorizing the financial transaction if the additional user identification data inputted by the user into the transactional device is correct; and
completing the financial transaction without permitting storing of the first or second image of the user's fingerprint, or copies thereof, into the transaction device or into any other device or database different than the entity's digital database, except temporarily if necessary for the processing of the financial transaction to be successful.

12. The computer network system of claim 11, wherein the financial transaction is a payment to a merchant, wherein the transaction device is a point-of-sale device comprising a fingerprint scanner, which is used to obtain the second image of the user's fingerprint, and wherein, the system further comprises a merchant server, which communicates with the entity's server and records the payment details.

13. The computer network system of claim 11, wherein said entity is a bank.

14. The computer network system of claim 13, wherein the at least one debit or credit account of the user is open at said bank.

15. The computer network system of claim 11, further comprising generating a fingerprint account number when registering the user's fingerprint, and associating said fingerprint account number with the first image of the user's fingerprint, and thus, with the at least one debit or credit account of the user.

16. The computer network system of claim 11, wherein the communicating of the fingerprint authentication results to the user through the transaction device comprises displaying user's name on the display of the transaction device and asking the user to confirm that the displayed name is user's name.

17. The computer network system of claim 11, wherein the communicating of the fingerprint authentication results to the user through the transaction device comprises displaying, for each of the at least one debit or credit account associated with the user's fingerprint, a portion of the account number of the at least one debit or credit account on the display of the transaction device and asking the user to select one of the displayed portion of the account number of the at least one debit or credit account, thus confirming that it corresponds to one of the at least one debit or credit account associated with the user's fingerprint and indicating that the financial transaction should be processed from the selected account.

18. The computer network system of claim 17, wherein the additional user identification data is a personal identification number (PIN) associated with the selected account.

19. The computer network system of claim 17, wherein the additional user identification data is a personal signature signed on the display of the transactional device.

20. The computer network system of claim 15, wherein the first image of the user's fingerprint and the user's fingerprint account number are associated with only one debit or credit account of the user, and wherein, communicating the fingerprint authentication results to the user through the transaction device comprises displaying on the display of the transaction device at least a portion of the user's fingerprint account number and asking the user to confirm that the displayed at least a portion corresponds to user's fingerprint account number.
